(19) United States
(12) Patent Application Publication
(10) Pub. No.: US 2020/0009424 A1
(43) Pub. Date: Jan. 9, 2020

(54) WHEELCHAIR EXERCISE TILT AND DYNAMIC TERRAIN SIMULATION SYSTEM

(71) Applicant: WHEELERS' PARAMILL INC., Boring, OR (US)

(72) Inventor: Larry Pestes, Boring, OR (US)

(21) Appl. No.: 16/460,614

(22) Filed: Jul. 2, 2019

Related U.S. Application Data
(60) Provisional application No. 62/694,795, filed on Jul. 6, 2018.

(51) Int. Cl. A63B 24/00; A61G 5/02; A63B 22/02

(52) U.S. Cl. CPC A63B 24/0087; A61G 5/02; A63B 2225/093; A63B 2024/009; A63B 22/0235

(57) ABSTRACT

Tilt and dynamic terrain simulation systems are provided which are couplable to a wheelchair treadmill and are configured to dynamically tilt the wheelchair during use of the wheelchair treadmill for simulating an uneven terrain condition. In some embodiments, the dynamic tilt system includes one or more elevation devices placed under a platform for tilting the platform of the wheelchair treadmill from a horizontal plane to a non-horizontal plane, and each of the one or more elevation devices is controllably adjustable to extend an adjustable support that is mounted to the platform between a first height and a second height. In some embodiments, each of the one or more elevation devices includes one or more actuators for controllably adjusting a height of the adjustable support between the first height and the second height.

### CROSS-REFERENCE TO RELATED APPLICATIONS

This application claims the benefit of and priority to U.S. Provisional Patent Application Ser. No. 62/694,795 filed on Jul. 6, 2018 and entitled “WHEELCHAIR EXERCISE TILT AND DYNAMIC TERRAIN SIMULATION SYSTEM,” which application is expressly incorporated herein by reference in its entirety.

### BACKGROUND

Exercise is an important activity for helping people get stronger, build endurance, reduce stress, and feel better. Exercise can be important for all types of people, including people who rely on the use of a wheelchair due to an injury or disability. Unfortunately, there are very few options for people in wheelchairs to perform exercise in traditional gyms. This can be particularly problematic when the individuals travel to hotels or seek treatment in medical facilities, and there is no equipment for facilitating exercise in a wheelchair.

Some treadmills have been designed for enabling a wheelchair user to perform the exercise from their wheelchair. For instance, a wheelchair user may push their wheelchair onto a specialized treadmill platform and drive their wheelchair on the treadmill similarly to how people may walk or run on a traditional treadmill.

Recently, a range of sports has been developed for disabled athletes, including wheelchair racing and many other sports. The wheelchairs used for racing have evolved to suit the specific needs of the sports and no longer resemble the usual everyday wheelchairs. For example, a modern racing wheelchair often has three wheels including a front wheel, connected by a central member of the frame with a seat, to two rear wheels.

Unfortunately, existing wheelchair treadmills are limited in their capabilities and are not specifically configured to accommodate the athlete/track wheelchairs having only three wheels. As such, the traditional wheelchair treadmill is not well-suited for accommodating a sports wheelchair for exercise, because the regular wheelchair treadmill may have difficulties to secure the sports wheelchair in place due to the single front wheel and lack of outer frame design (which is where traditional wheelchair treadmills attach to the traditional wheelchairs).

Furthermore, existing wheelchair treadmills do not adequately simulate a variety of terrains that a typical wheelchair user will encounter, such as uneven pavement and trails. Instead, traditional wheelchair treadmills only simulate flat training surfaces.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed embodiments are directed to exercise equipment, especially treadmills, which are configured for use with wheelchairs and which are further configured to simulate uneven terrains during use, as well as methods of use.

In some embodiments, the disclosed treadmills include a platform for supporting the wheelchair, a dynamic tilt system coupled to the platform and that is configured to dynamically tilt the wheelchair during the use of the wheelchair treadmill for simulating a terrain condition, and an electronic control configured for controlling the dynamic tilt system.

In some embodiments, the terrain condition includes an uneven terrain condition comprising a non-horizontal plane condition corresponding to an existing outdoor or natural terrain.

In some embodiments, the dynamic tilt system includes one or more elevation devices placed under the platform for tilting the platform of the wheelchair treadmill from a horizontal plane to a non-horizontal plane, and each of the one or more elevation devices is controllably adjustable to extend an adjustable support that is mounted to the platform between a first height and a second height.

In some embodiments, each of the one or more elevation devices includes one or more actuators for controllably adjusting a height of the adjustable support between the first height and the second height.

In some embodiments, the electronic control is configured with one or more interface buttons for controlling the one or more actuators and for causing the adjustable supports to extend or retract from the elevation devices and for causing the adjustable supports to move and/or to stop moving between the first height and the second height.

In some embodiments, at least one of the one or more actuators is powered by electric current. The at least one of the one or more actuators may include a solenoid that is powered by electric current. In some embodiments, at least one of the one or more actuators is powered by hydraulic fluid pressure. In some embodiments, at least one of the one or more actuators is powered by pneumatic pressure.

In some embodiments, the dynamic tilt system includes at least two adjustable supports and at least two corresponding actuators. In some embodiments, the dynamic tilt system includes at least three adjustable supports and at least three corresponding actuators. In some embodiments, the dynamic tilt system includes at least four adjustable supports and at least four corresponding actuators.

In some embodiments, the wheelchair treadmill further includes one or more rollers exposed through the platform for engaging the two driving wheels of the wheelchair during use of the wheelchair. The height of each of the one or two rollers may be adjustable, and the dynamic tilt system may be configured to dynamically adjust the height of each of the one or two rollers during use of the wheelchair treadmill.

In some embodiments, the wheelchair treadmill further includes a receptacle attached to the platform for receiving and restricting movement of a single front wheel of a track wheelchair. The height of the receptacle may be adjustable, and the dynamic tilt system may be configured to dynamically adjust the height and/or tilt of the receptacle during use of the wheelchair treadmill.

In some embodiments, the height of the receptacle and the height of each of the rollers are all adjustable, and the dynamic tilt system is configured to dynamically adjust each of the height of the receptacle and the rollers during use of the wheelchair treadmill system.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a racing/track wheelchair being placed on an example wheelchair treadmill embodying the subject invention;

FIG. 2 illustrates a perspective view of a wheelchair treadmill embodying the subject invention;

FIG. 3 illustrates a front elevation view showing a wheelchair treadmill;

FIG. 4 illustrates a back elevation view showing a wheelchair treadmill;

FIG. 5 illustrates a top elevation view showing a wheelchair treadmill;

FIG. 6 illustrates a bottom elevation view showing a wheelchair treadmill that shows non-limiting and exemplary placements for elevation devices;

FIG. 7 illustrates one embodiment of an elevation device;

FIG. 8 illustrates one embodiment of a wheelchair treadmill in which elevation devices are used to create an uneven (non-horizontal) exercise plane;

FIG. 9 illustrates another example of an elevation device that is specifically configured with a roller;

FIGS. 10A and 10B illustrate examples of an actuator that may be implemented to cause the elevation device to create an uneven exercise plane;

FIG. 11 illustrates an example user interface that may be implemented to allow a user to control the simulation system.

### DETAILED DESCRIPTION

Disclosed embodiments are directed to exercise equipment, especially treadmills, which are configured for dynamically simulating uneven terrains during use.

In some embodiments, the disclosed treadmills include a platform for supporting the wheelchair, a dynamic tilt system coupled to the platform and configured to dynamically tilt the wheelchair during use of the wheelchair treadmill for simulating a terrain condition, and an electronic control configured for controlling the dynamic tilt system.

In some embodiments, the terrain condition includes an uneven terrain condition corresponding to an existing outdoor or natural terrain.

In some embodiments, the dynamic tilt system includes one or more elevation devices placed under the platform for tilting the platform of the wheelchair treadmill from a horizontal plane to a non-horizontal plane, and each of the one or more elevation devices is controllably adjustable to extend an adjustable support that is mounted to the platform between a first height and a second height.

In some embodiments, each of the one or more elevation devices includes one or more actuators for controllably adjusting a height of the adjustable support between the first height and the second height.

In some embodiments, the electronic control is configured with one or more interface buttons for controlling the one or more actuators and for causing the adjustable supports to extend or retract from the elevation devices and for causing the adjustable supports to move and/or to stop moving between the first height and the second height.

In some embodiments, at least one of the one or more actuators is powered by electric current. The at least one of the one or more actuators may include a solenoid that is powered by electric current. In some embodiments, at least one of the one or more actuators is powered by hydraulic fluid pressure. In some embodiments, at least one of the one or more actuators is powered by pneumatic pressure.

In some embodiments, the dynamic tilt system includes at least two adjustable supports and at least two corresponding actuators. In some embodiments, the dynamic tilt system includes at least three adjustable supports and at least three corresponding actuators. In some embodiments, the dynamic tilt system includes at least four adjustable supports and at least four corresponding actuators.

In some embodiments, the wheelchair treadmill further includes one or more rollers exposed through the platform for engaging the two driving wheels of the wheelchair during use of the wheelchair. The height of each of the one or two rollers may be adjustable, and the dynamic tilt system may be configured to dynamically adjust the height of each of the one or two rollers during use of the wheelchair treadmill.

In some embodiments, the height of the receptacle and the height of each of the rollers are all adjustable, and the dynamic tilt system is configured to dynamically adjust each of the height of the receptacle and the rollers during use of the wheelchair treadmill system.

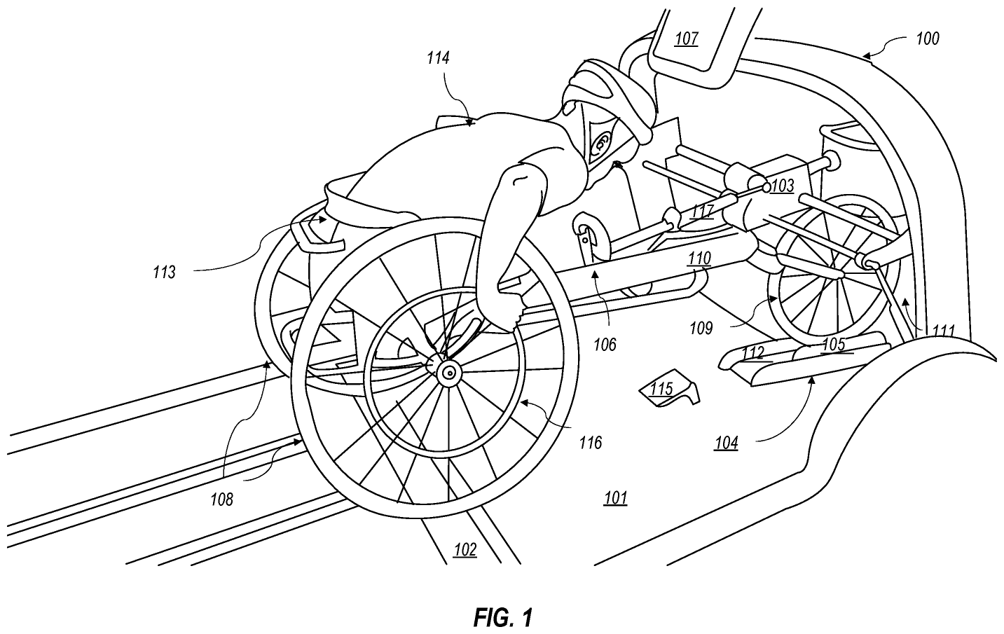

The following now refers to an exemplary wheelchair treadmill into which the tilt and dynamic terrain simulation systems described herein may be implemented. Although the disclosure will focus on implementation of the tilt and dynamic terrain simulation systems into the wheelchair treadmill shown in FIGS. 1-5, it will be appreciated that these systems may be implemented into other wheelchair treadmills and/or other treadmills. For example, the systems described herein may be implemented into the wheelchair treadmills described in U.S. Pat. No. 6,645,127 and U.S. Patent Publication 2018/0071609, invented by Larry L. Pestes, which are incorporated herein by reference in their entireties, as well as other wheelchair treadmills, and even running/walking treadmills.

### Track/Racing Wheelchair Embodiments

Referring now to FIG. 1, a racing or track wheelchair 113 is placed on an example wheelchair treadmill 100. The racing wheelchair 113 includes two driving wheels 108 and a single front wheel 109 that is connected to the wheelchair with a central crossbar 110. Each of the driving wheels includes a hand rim 116. A user 114 pushes the hand rims 116 to drive the driving wheels forward.

The wheelchair treadmill 100 includes a platform 101, one or more rollers 102, a fastener assembly 103 coupled to the platform 101, and a receptacle 104. The one or more rollers 102 are exposed through the platform 101 for engaging the two driving wheels 108 of the wheelchair 113 during the use of the wheelchair treadmill 100. The receptacle 104 is attached to the platform 101 for receiving and restricting movement of the front wheel 109 in at least two directions, including (but are not limited to) the back-and-forth directions and/or the left-and-right directions. The fastener assembly 103 is configured with a clamp 106 for selectively clamping onto the crossbar 110 of the wheelchair and for securing the wheelchair 113 in a fixed location during use of the wheelchair treadmill 100.

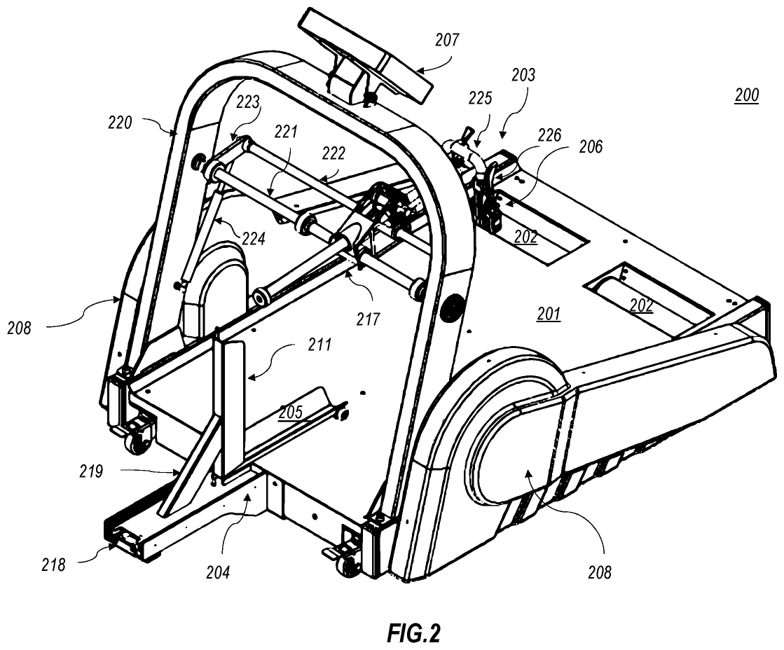

In FIG. 1, the wheelchair treadmill 100 has a single roller 102. Both of the driving wheels 108 of the wheelchair 113 are in contact with the single roller 102. In another implementation, referring to FIG. 2, the wheelchair 200 includes two rollers 202, each of which supports one of the driving wheels of the wheelchair 113. Having two separate rollers allows a user to selectively exercise one side of his or her body separately. Because having one side that is stronger than the other side of one's body is a fairly common problem, the two-roller implementation allows a user to strengthen the weaker side of the body separately and/or set up different resistance for each side.

Each of the one or more rollers may be connected to a separate flywheel 208. Resistance may be imposed on each of the rollers and/or the flywheels selectively, such that a user may choose different exercise intensities for each side of their body.

Referring back to FIGS. 1 and 2, the wheelchair treadmill 100, 200 includes a receptacle 104, 204. The receptacle 104, 204 may include a trough 105, 205 that extends from a front end to a back end of the receptacle 104, 204. The receptacle 104, 204 may further include a stop 111, 211 disposed at the front end of the trough and configured to stop the front wheel 109 from rolling forward beyond the front end of the receptacle 104. The trough 105, 205 may be slidably mounted on the platform 101, 201 so that when the front wheel of the wheelchair presses up against the trough, it will slide forward. It may also have a spring (not shown) or other retractable device(s) for retracting the trough back to an original resting position (shown in FIG. 2) when the wheelchair is removed from the treadmill.

The receptacle 104, 204 and the one or more rollers 102, 202 may be positioned at least partially above a top planar surface of the platform 101, 202 to facilitate exercise and movement of the driving wheels on the wheelchair without being obstructed by the platform.

It will be appreciated that the receptacle 104, 204 may include various different components. For example, referring to FIG. 2, the receptacle 204 may include a base 218 attached to the platform 201. A support member 219 may be further mounted on the base 218 forming a triangle support for the stop 211. The trough 205 and/or the stop 211 may be slidably mounted on the base 218, such that the trough 205 and/or the stop 211 may slide back-and-forth between a resting position (FIG. 2) and an extended position (FIG. 1).

Referring to FIG. 1, the wheelchair treadmill 100 may further include a ramp 115 mounted to the platform 101 near the back end of the trough 105. The ramp 115 is operable for facilitating loading and unloading the front wheel 109 onto the trough 105. For example, before the front wheel 109 is loaded onto the trough 105, trough 104 rests in close proximity to ramp 115 in a resting position such that the front wheel 109 may be driven up ramp 115 onto the trough 105 of the receptacle 104. After the front wheel 109 is loaded onto the trough 105, the receptacle 104 responds to continued forward motion of the front wheel 109 by sliding forward into an extended position (FIG. 1) as the front wheel 109 pushes against the stop 111.

The receptacle 104 may further include a back stop 112 placed near the back end of the trough 105. The back stop 112 is configured to stop the front wheel 109 from sliding backward beyond the back stop 112.

One side of the back stop 112 may be mounted to the back end of the trough 105, and the other side of the back stop 112 may be capable of rotating along the sagittal plane. When loading the front wheel 109 of the wheelchair 113 into the trough 103, the other side of the back stop 112 rotates down onto the platform 101 and/or connects to the ramp 115 extending the ramp 115 all the way to the trough 105 helping facilitate loading the front wheel 109 into the trough 105. After the front wheel 109 is loaded into the trough 105, the back stop 112 may be configured, in some instances, to rotate onto the trough 105, thereby forming a stop for stopping the front wheel 109 from sliding backward while exercising. Similarly, after the exercise is completed, the back stop 112 may rotate down onto the platform 101 again helping facilitate unloading the front wheel 109 out of the trough 105.

The back stop 112 may be slidably mounted on the trough 104. When loading or unloading the front wheel 109 of the wheelchair 113 into or out of the trough 103, the back stop 112 may slide down the trough and onto the platform 101, and/or connect to the ramp 115 extending the ramp 115 all the way to the trough 105 helping facilitating loading or unloading the front wheel 109 into or out of the trough 105.

As illustrated in FIGS. 1 and 2, the wheelchair treadmill 100, 200 includes a fastener assembly 103, 203. The fastener assembly 103 may consist of only a single clamp 106 configured for clamping onto any portion of the wheelchair 113, as opposed to the two clamp systems used for some other treadmill products. The single clamp can be beneficial for costing less than the two clamp systems. The single clamp system can also be configured to be selectively adjustable to clamp onto wheelchair frames/crossbars that have different diameters.

The fastener assembly 103, 203 may include an adjustable arm 117, 217 that is configured to slidably move horizontally between a left side and a right side of the wheelchair treadmill 100, 200. The fastener assembly 103, 203 may further be configured to move vertically, in a substantially perpendicular direction relative to the platform 101, 201. In some instances, the adjustable arm is also adjustable in length and/or configured to slide longitudinally along its length (e.g., fore and aft).

The wheelchair treadmill 100, 200 may further include an electronic control 107, 207 and power drivers for rotating the one or more rollers 102. In some implementations, the electronic control 107 is further configured to control a powered slide for selectively sliding the receptacle 104 between at least two different positions relative to the platform 101, such as the left-and-right directions and the front-and-back directions. The electronic control 107 is connected to a power supply (not shown).

The positioning and orientation of the fastener assembly may be adjustable manually by the user operating the wheelchair treadmill. Additionally or alternatively, the fastener assembly 103 may further include at least one electrically powered component for selectively controlling movement of the fastener assembly 103 in at least one direction, such as substantially horizontal directions and/or substantially vertical directions relative to the plane of the platform 101. The electrically powered component may be connected to the same electronic control 107.

Various structures may be implemented for mounting and/or constructing the fastener assembly 103. For example, referring to FIG. 2, the wheelchair 200 may further include a frame 220 attached to the front portion of the platform 201. The frame 220 may extend to both the left and right side of the platform 201. The height of the frame 220 may be an approximate eye level of a user sitting on the wheelchair while exercising. The height of the frame 220 may be adjustable to fit the user's height or eye level. The electronic control 107 may be tiltably mounted on the top of the frame 220, such that the angle of the electronic control 107 may be tilted/tiltable to a desirable angle facing the user.

The fastening assembly 203 may be mounted on the frame 220. As illustrated in FIG. 2, a pair of horizontal bars 221 and 222 are adjustably mounted on the frame 220, and the fastening assembly 203 is slidably mounted on the pair of horizontal bars 221, 222. The first horizontal bar 221 is attached on the frame 220. The left end of the first horizontal bar 221 is attached on the left side of the frame 220, and the right end of the first horizontal bar 221 is attached on the right side of the frame 220. The second horizontal bar 222 is connected to the first horizontal bar by one or more adjustable connector plates 223. One or more adjustable support members 224 (e.g., pistons) are configured to support the second horizontal bar 222. One end of the adjustable support member 224 is attached to a side of the frame 220. The other end of the adjustable support member 224 is attached to an end of the second horizontal bar 222. The length and the angle of the adjustable support member 224 is adjustable. When the adjustable support member 224 is extended longer, the side of the adjustable connector plate 223 that is attached to the support member 223 flexes up in a sagittal plane. Accordingly, the second horizontal bar 222 is raised up and also moved slightly forward following the connector plate 223. This is one way to move the clamp 206 (described below) up or down, relative to the treadmill platform 201.

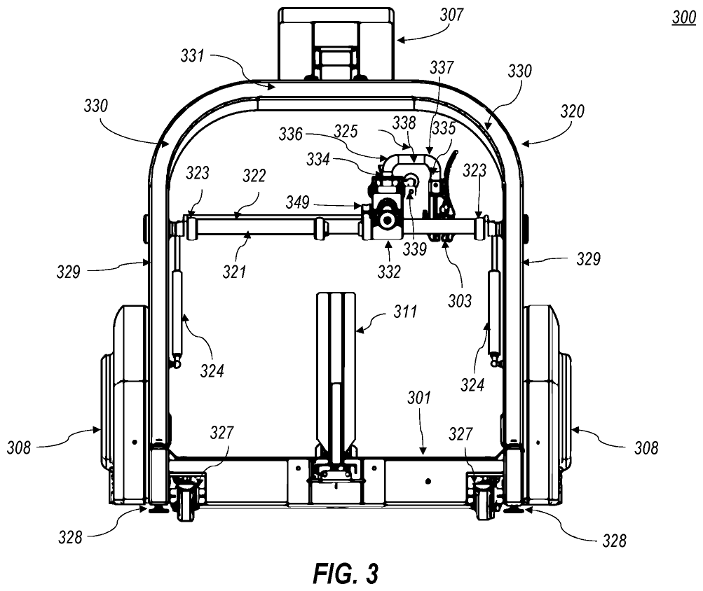

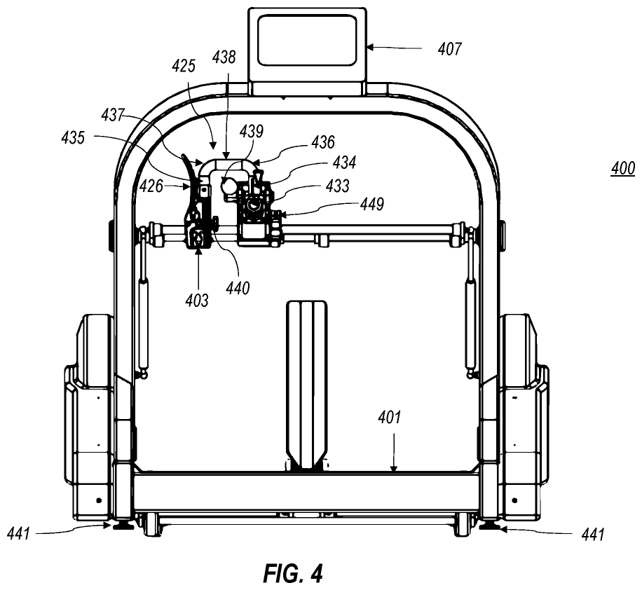

The fastening assembly 203 is slidably mounted on the pair of horizontal bars 221, 222. The fastening assembly 203 is slidable in the left-and-right direction, relative to an orientation of the treadmill, along with the pair of horizontal bars 221, 222 to accommodate different positioning of the wheelchair crossbar. For example, if the clamp 206 is to be clamped onto a side portion of a traditional wheelchair, the clamp 206 would be adjusted to the side of the horizontal bars 221, 222 on which the portion of the wheelchair is located. Another example, if the clamp 206 is to be clamped onto a center crossbar of the wheelchair, the clamp 206 would be adjusted to the center of the horizontal bars 221, 222. When the desired horizontal position of the fastening assembly 203 is reached, the horizontal position of the fastening assembly 203 may be locked by rotating clamp handle 349, 449 (see FIG. 3, FIG. 4) into a locked position.

The fastening assembly 203 may include an adjustable arm 217 and a single clamp 206. The adjustable arm 217 is slidably and perpendicularly mounted to the pair of horizontal bars 221, 222. The single clamp 206 is attached to the back end of the adjustable arm 217. The length of the adjustable arm 217 may be adjustable, as such the location of the clamp may be adjusted in backward-and-forward directions relative to the treadmill platform 201. When the desired length of the adjustable arm 217 is reached, the length of the adjustable arm 217 may be locked by rotating clamping rod 339, 439 (see FIG. 3, FIG. 4) into a locked position.

Furthermore, when the adjustable support member 224 extends longer, the connector plates 223 flexes and raises the second horizontal bar 222. Accordingly, the adjustable arm 217 tilts, and the back end of the adjustable arm 217 raises the clamp 206 up higher. As such, the adjustable arm 117 is configured to the move the clamp 206 vertically, in a substantially perpendicular direction relative to the platform 201.

The clamp 206 may be mounted to the adjustable arm 217 through a connector joint 225. The connector joint 225 may also be adjustable and further allow the angle of the clamp 206 to be adjusted based on the position and/or angle of a crossbar or frame of a wheelchair. For example, the front wheel of a racing wheelchair is often smaller than the two driving wheels, therefore, the front end of the crossbar that connects the front wheel is often lower than the back end of the crossbar that connects the back wheels, forming an angle relative to the platform 210. And, different wheelchairs may have different crossbar assemblies, therefore, the angles of the crossbar of different wheelchairs may be different. The adjustable connector joint 225 allows the clamp to be adjusted to fit the angle of crossbars of different wheelchairs.

The clamp 206 is an adjustable toggle clamp including a toggle handle 226. The diameter of the clamp 206 may be adjusted to the approximate diameter of a crossbar of the wheelchair, first. Then, the clamp 206 may be further secured by pushing up or down the toggle handle 226 to secure the clamp 206 to the wheelchair crossbar.

FIG. 3 illustrates a front elevation view of an example wheelchair treadmill 300, which may correspond to the wheelchair treadmill 200 of FIG. 2. The exercising apparatus 300 includes a substantially horizontal platform 301. The left, right, front and back directions are based on a user's perception. Since FIG. 3 is a front elevation view of the exercising apparatus 300, the left and right side of the figure is opposite to the user's view, i.e., the left side of the figure is actually the right side of the user, and the right side of the figure is actually the left side of the user.

Two flywheels 308 are placed on the left and right side of the platform 301. A frame 320 is mounted on the top of the platform 301. The frame 320 includes a left and a right vertical portions 329 that are substantially vertically mounted on the left and right side of the platform 301. The frame 320 further includes a left and a right connection portions 330 that have a curved shape, connecting the left and right vertical portions to a horizontal portion 331. An electronic control 307 is mounted on the top of the horizontal portion 331. The flywheels 308 and the electronic control 307 may be powered by a same power source (not shown). One or more power cables may be extended through the frame 320 including the left and right vertical portions 329, the left and right curve shaped connection portions 330, and the top horizontal portion 331 to the electronic control 307.

A first horizontal bar 321 is attached to the left and right vertical portions 329 of the frame 320 by both left and right ends of the first horizontal bar 321. A second horizontal bar 322 is parallelly connected to the first horizontal bar 321 by a left and right connector plates 323 placed on each left and right ends of the first and second horizontal bars 321, 322. A left and a right adjustable support members 324 are mounted on the frame 320 and are configured to support the second horizontal bar 322 on each left and right ends of the second horizontal bar 322. The angle and the length of the adjustable support members 324 are both adjustable along the sagittal plane. When the length of the adjustable support members 324 extends longer, the second horizontal bar 322 raises and the angle of the adjustable support members 324 relative to the platform 301 increases.

A single clamp 303 is slidably mounted on the pair of horizontal bars 321, 322. Different configurations may be implemented to mount the clamp 303 onto the pair of horizontal bars 321, 322. For example, the clamp 303 may be mounted on an adjustable arm (not clearly shown), and the adjustable arm may be slidably and perpendicularly mounted on the one or both of the pair of horizontal bars 321, 322 by one or more bar mounts 332 that includes a clamping handle 349. The bar mount 332 may be tightened or loosened by rotating the clamping handle 349 into a locked position. When the bar mount 332 is loosened, the adjustable arm is slidable in the left-and-right direction between the left and right vertical portions 329 of the frame 320. When the bar mount 332 is tightened, the adjustable arm is being secured on the pair of horizontal bars 321, 322. A user may selectively secure the adjustable arm at any location between the left and right vertical portions 329 of the frame 320.

Furthermore, the adjustable support members 324 may further adjust the location of the clamp 303. When the adjustable support members 324 extend longer, the second horizontal bar 322 raises up, and also moves forward slightly towards the front of the exercising apparatus 300. Accordingly, the adjustable arm that is perpendicularly mounted on both of the horizontal bars 321, 322 tilts upward and raises the clamp 303 that is attached on the back end of the adjustable arm. As such, the clamp 303 is adjustable in substantially vertical directions relative to the treadmill platform.

The length of the adjustable arm may also be adjustable, thus, further adjust the location of the clamp 303 in the backward-and-forward directions relative to the treadmill platform. It is possible for the clamping rod 339 to be configured to fix the vertical adjustment of the clamp 303, in addition or as an alternative to locking the length of the adjustable arm.

Once the adjustable support members 324 is secured at a particular length and angle, the relative location of the adjustable arm on the horizontal bars 321, 322 is secured, and the length of the adjustable arm is secured, the location of the clamp 303 is secured. The configuration illustrated in FIG. 3 allows the location of the clamp 303 to be adjusted in all 3 dimensions, including left-and-right directions, back-and-forth directions and vertical directions relative to the treadmill platform.

Additionally, as illustrated in FIG. 3, there may further be a connector joint 325 connecting the bar mount 322 and the clamp 303. The connector joint 325 may include a first and second vertical portions 334, 335, a first and second corner portions 336, 337, and a horizontal portion 338. The first vertical portion 334 may be adjustably secured on the first and second horizontal bars 321, 322 in a sagittal plane by a twistable handle 433 (see FIG. 4). A user may flex the first vertical portion 334 forward or backward to a desired position, e.g., a substantially vertical direction that is perpendicular to the platform 301. Once the first vertical portion 334 is adjusted to a desired position, a user may secure the first vertical portion 334 by tightening the twistable handle 433.

The first and second corner portions 336, 337 may be curve shaped to connect the vertical portions 334, 335 and the horizontal portion 338 together. The clamp 303 may be adjustably connected to the second vertical portion 335. The clamp 303 may be adjusted in any plane at any angle relative to the parallel bars 321, 322.

Each of the connections between the vertical portions 334, 335, corner portions 336, 337, and horizontal portion 338 may be adjustable. For example, the connection between the first vertical portion 334 and the first corner portion 336 may be adjustable in a transverse plane, such that the first vertical portion 334 would serve as a center axis, and the connector joint 325 including all the portions 335-338 would turn around the center axis in the transverse plane. The connection between the horizontal portion 338 and the second corner portion 337 may be adjustable in a sagittal plane; and the second corner portion 337 and the second vertical portion 335 may be adjustable in a transverse plane. Accordingly, the clamp attached to the connector joint 325 may be adjustable in all three dimensions, which allows clamping onto any portion of the wheelchair that may be placed at any angle and/or any plane relative to the platform.

The wheelchair treadmill 300 may also include a pair of front wheels 327, such that the exercising apparatus 300 may be moved easily. The wheelchair treadmill 300 may also include one or more adjustable front jacks 328 under the front portion of the platform 301. The front jacks 328 may be adjusted individually to keep the platform 301 substantially horizontal when placed on a non-flat surface.

FIG. 4 is a back elevation view of the exemplary wheelchair treadmill 400, which may correspond to the wheelchair treadmill 200 of FIG. 2 and/or 300 of FIG. 3. Similar to FIG. 3, FIG. 4 shows a similar implementation of the fastener assembly of the wheelchair treadmill 400. The clamp 403 is adjustably mounted on the connector joint 425 that include a first and second vertical portions 434, 435, a first and second corner portions 436, 437 and a horizontal portion 438. From the back elevation view, several twistable handles are better illustrated. For example, the twistable handle 433 is configured to allow adjustment and securing of the first vertical portion 434 in the sagittal plane, and/or the connection between the first vertical portion 434 and the first connector portion 436 in the transverse plane; the twistable handle 440 is configured to adjust the diameter of the clamp 403 to the proximate diameter of a crossbar of the wheelchair; and the toggle handle 426 is configured to further secure the crossbar in place.

As illustrated in FIG. 4, the wheelchair treadmill may further include one or more adjustable back jacks 441 under the back portion of the platform 401. Similar to the one or more front jacks 328 illustrated in FIG. 3, the back jacks 441 may also be adjusted individually to maintain the platform horizontal, especially when the wheelchair treadmill 400 is placed on a non-flat surface. The front and back jacks 328 and 441 may also be powered by the same power source (not shown), and be controlled by the same electronic controller 307, 407.

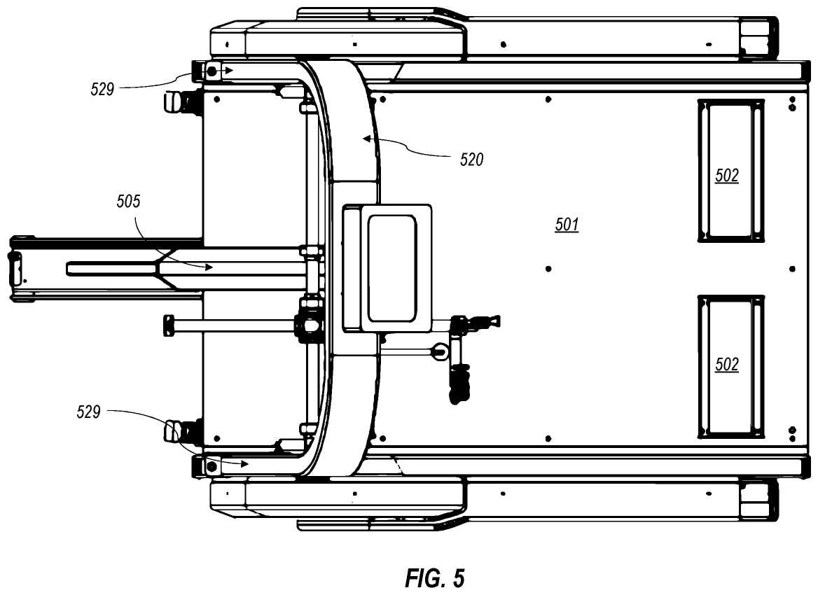

FIG. 5 illustrates a top elevation view of an example wheelchair treadmill, which may correspond to the wheelchair treadmill 200 of FIG. 2, 300 of FIG. 3, and/or 400 of FIG. 4. In this view, the two rollers 502 are better illustrated. The two rollers 502 are placed in two rectangular openings located at a back portion of the platform 501. In some implementations, the height of the two rollers 502 may be substantially level relative to the platform 501. In other implementations, the top of the two rollers 502 may be slightly above the platform 501 and at a similar level of the trough 505. The trough 505 is configured for securing the front wheel of the wheelchair in at least two directions (e.g., forward/backward and lateral right/left direction(s)). The rollers 502 are also configured for engaging the two back driving wheels of the wheelchair. When the rollers 502 and the trough 505 are placed at a substantially same level, the front wheel and the back wheels of the wheelchairs are level. As such, the user exercising on the wheelchair would feel as if he/she was exercising on a flat surface.

### Tilt and Dynamic Terrain Simulation Systems

Traditional wheelchair treadmills only simulate flat terrains. However, there is a need and desire for wheelchair treadmills that can simulate uneven terrains. Such devices would be useful, for example, to facilitate training for developing greater core strength and to provide specialized training for track and outdoor events that are performed on uneven terrains. The systems described herein may be implemented to provide wheelchair athletes and other users with wheelchair treadmills that can simulate uneven terrain and thus provide improved and diverse exercise opportunities.

A tilt and dynamic terrain simulation system of the disclosed embodiments includes one or more elevation devices mounted to or configured to be mounted to a wheelchair treadmill. The elevation devices include adjustable supports and actuators for altering the height/angle of a wheelchair treadmill to which the elevation devices are coupled.

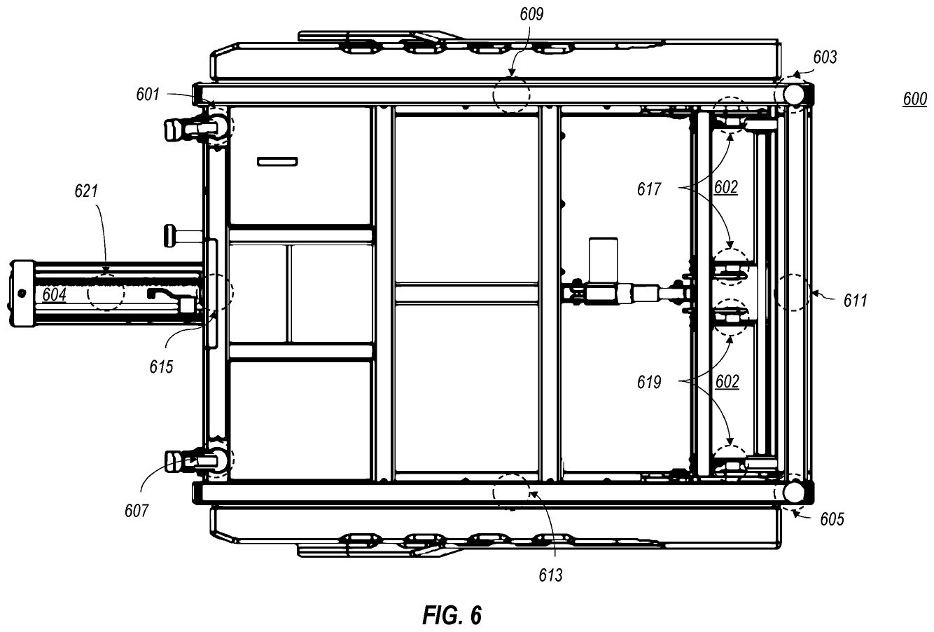

Attention is directed towards FIG. 6, which shows exemplary locations on a bottom view of a wheelchair treadmill 600, where one or more elevation devices may be positioned. The wheelchair treadmill 600 may correspond to the wheelchair treadmill 200 of FIG. 2, 300 of FIG. 3, 400 of FIG. 4, and/or 500 of FIG. 5, or any other treadmill. It will be appreciated, however, that the locations shown are not exhaustive, but exemplary only. It will also be appreciated that while FIG. 6 illustrates a view of a wheelchair treadmill that is specifically configured to accommodate three-wheeled track/racing wheelchairs (as described in FIGS. 1-5), the embodiments of the invention also apply to treadmills that are configured for use with traditional wheelchairs having four wheels.

As illustrated in FIG. 6, the elevation device(s) may be positioned at or near corners of the wheelchair treadmill, such as positions 601, 603, 605 and/or 607. In such an arrangement, elevation devices positioned at 601 and 607 may be activated to elevate a front portion of the wheelchair treadmill 600 to simulate an uphill terrain. Similarly, elevation devices positioned at 603 and 605 may be activated to elevate a rear portion of the wheelchair treadmill 600 to simulate a downhill terrain. Elevation devices positioned at 601 and 603 may be activated to elevate a left portion of the wheelchair treadmill 600 to simulate a left-slanted terrain. Similarly, elevation devices positioned at 605 and 607 may be activated to elevate a right portion of the wheelchair treadmill 600 to simulate a right-slanted terrain.

As is further illustrated in FIG. 6, elevation devices may additionally or alternatively positioned centrally along sides of the wheelchair treadmill 600, such as at positions 609, 611, 613, and 615. In such a configuration, an elevation device at 615 may be activated for an uphill simulation, an elevation device at 609 may be activated for a left-slanted simulation, an elevation device at 611 may be activated for a downhill simulation, and an elevation device at 613 may be activated for a right-slanted simulation.

It should be noted that activation of an elevation device need not be considered binary, and those skilled in the art will recognize that each elevation device may be activated or adjusted to remain at a maximum height, a minimum height, and all elevations between the maximum and minimum, for any predetermined duration(s) of time, as controlled by the control panel and based on user interactions (user selections of settings) at the control panel.

Accordingly, for example, if an elevation device located at 615 is activated to a maximum elevation to simulate an uphill terrain, elevation devices located at 609 and 613 may also be activated to a less-than-maximum elevation/height to provide support as the wheelchair treadmill 600 simulates the uphill terrain. In other examples, different combinations of elevation devices are used with maximum and/or less-than-maximum elevations/heights, at different times to simulate different tilt/slope conditions.

Other illustrative elevation device locations are shown in FIG. 6. For example, in some embodiments, the elevation devices are arranged to elevate one or more rollers 602 of the wheelchair treadmill 600 rather than lift the entire wheelchair treadmill. Elevation devices may be coupled at locations 617 and/or 619 corresponding to side supports for the rollers. Furthermore, the elevation devices may be arranged to elevate receptacle 604 in conjunction with rollers 602, such as by placing an elevation device at 621. In such a configuration, elevation devices located at 621, 617, and 619 may be activated in various manners to simulate uphill, downhill, right-slanted, left-slanted, and/or other terrains.

Arranging the elevation devices to lift only the rollers 602 and the receptacle 604 may provide substantial benefits. In such an arrangement, for example, the elevation devices need only be manufactured to support the weight of the wheelchair, the user, the rollers, and the receptacle, rather than needing to further support the weight of the entire wheelchair treadmill apparatus. Thus, elevation devices in such an arrangement would not require as much lifting force and may thus be more simple, smaller, and/or easily integrated into the design of the wheelchair treadmill.

While the description of FIG. 6 has focused primarily on simulating four terrain profiles (uphill, downhill, right-slanted and left-slanted), those skilled in the art will recognize that other terrain profiles are made possible by the elevation device placements described herein. For example, elevation devices located at 603, 605, and 607 may be utilized to simulate a downhill, left-slanted terrain. In another example, where elevation devices are located at 609, 611, 613, and 615, elevation devices located at 615 and 613 may be at least partially elevated to effect an uphill, right-slanted terrain simulation.

Furthermore, it will be appreciated that although the description of FIG. 6 has described certain elevation device locations as being associated with others (e.g., locations 601, 603, 605, and 607), other combinations of elevation device locations are within the scope of this disclosure. For example, elevation devices may be placed at 617 and 619 (on the roller supports) and on 601 and 607 (near corners of the wheelchair treadmill 600) in order to simulate terrains as desired by the user. However, it will be appreciated that the scope of this disclosure includes the use of at least two different elevation devices located at any desired locations on the wheelchair treadmill in such a manner as to create an uneven (non-horizontal-relative to the ground) training surface.

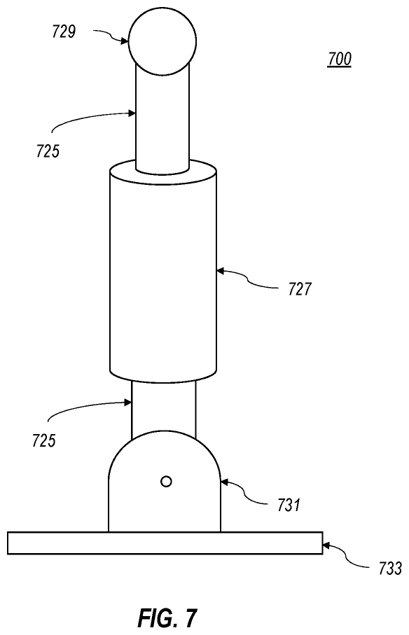

FIG. 7 illustrates a simplified schematic representation of an elevation device 700, which may be positioned with respect to a wheelchair treadmill at the locations described in FIG. 6 or at any other locations.

In some embodiments, an elevation device 700 includes an actuator 727, one or more adjustable supports 725, and one or more pivots 729, 731. Any type of actuator may be used in an elevation device 700 of the present disclosure. For example, the actuator 727 of elevation device 700 may be a fluid-power linear actuator, such as a hydraulic or pneumatic actuator which utilizes a pump. In a hydraulic system, the pump may be reversible to move fluid between reservoirs to elevate or lower the adjustable support(s) 725. In a pneumatic system, the pump may be utilized to pressurize the air in a reservoir underneath the adjustable support(s) 725 to elevate the adjustable support(s) 725, and the system may be arranged to release the pressure for a controlled decline of the adjustable support(s).

In fluid-power systems any suitable pump(s) may be utilized, such as a reciprocating compressor pump, a rotary vane pump, an axial, radial, or mixed flow centrifugal pump, or a positive displacement pump such as a rotary lobe pump, progressing cavity pump, rotary gear pump, piston pump, diaphragm pump, screw pump, or gear pump.

In some embodiments, electromechanical actuators are utilized as actuators 727 in elevation devices 700. For example, a screw actuator may be utilized which includes an electric motor coupled to a screw which is threadedly connected to the adjustable support(s) 725 such that activating the electric motor causes the adjustable support(s) to elevate or decline, depending on the rotation direction of the electric motor and screw.

In another example, departing from the simplified schematic representation of FIG. 7, an actuator 727 may include an electric motor coupled to an adjustable support 725 which may be embodied as an elongated tensioning member (e.g., a cord or wire). The elongated tensioning member may run through one or more spools and/or pulleys and, at an opposing end, be coupled to a part of the wheelchair treadmill (such as positions corresponding to those denoted in FIG. 6) such that when the electronic motor rotates, the elevation of the wheelchair treadmill changes depending on the direction the electric motor is rotating.

Other electromechanical actuators not fully described herein are within the scope of this disclosure, such as rack and pinion systems, cam systems and/or telescoping actuators.

In yet other embodiments, the actuator 727 elevates (extends) and/or lowers (retracts) the adjustable support(s) 725 via electromagnetic force. For example, in some embodiments, the actuator 727 includes a solenoid surrounding a core made of magnetic material (e.g., iron) and the adjustable support 725 includes a conductive material that surrounds the solenoid and core of the actuator 727. When an electrical current is run through the solenoid of the actuator 727, the electromagnetic field induced by the current causes a separate current in the conductive material of the adjustable support 725. An electromagnetic field induced by the current of the conductive material of the adjustable support 725 opposes the electromagnetic field induced by the current in the solenoid of the actuator 727, resulting in a lifting force on the adjustable support 725. The lifting force is operable to lift the adjustable support 725 to lift the wheelchair treadmill to a desired tilt to simulate an uneven terrain.

Other exemplary actuators which may be used in an elevation device 700 include, but are not limited to vacuum actuators or other magnetic actuators, and it should also be noted that combinations of the actuator types described herein may be utilized in one or more elevation devices 700.

In some embodiments, the adjustable supports of the elevation devices are configured to extend and retract between a first height and a second height in a range of about 0.0 inches (first/minimum height) to about 12 inches (second/maximum height). In other embodiments, the adjustable supports of the elevation devices are configured to extend and retract between a range of about 0.0 inches to about 9 inches. In other embodiments, the adjustable supports of the elevation devices are configured to extend and retract between a range of about 0.0 inches to about 6 inches. In other embodiments, the adjustable supports of the elevation devices are configured to extend and retract between a range of about 0.0 inches to about 3 inches. As previously discussed, the adjustable supports of the elevation devices are configured to extend and retract during controlled use of actuators (e.g., actuators 727).

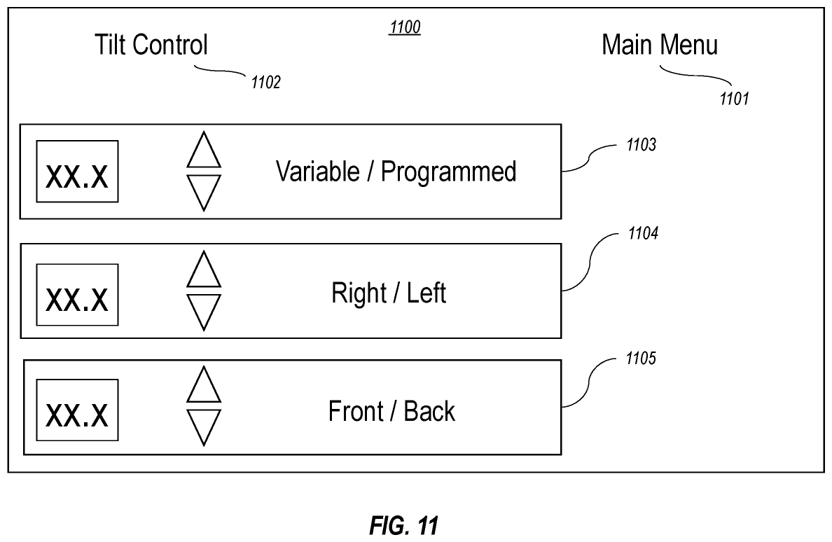

These actuators 727 are, in some embodiments, controllable by an electronic control panel, such as electronic control 107, 207, 307, 407 described hereinabove, and/or the control interface 1100 shown in FIG. 11, which is electrically connected to the actuators or corresponding actuator sensor/controllers (not shown), which receive input from the electronic control to trigger the functionality of the actuators.

Alternatively, a dedicated electronic control system separate from the wheelchair treadmill can be used to wirelessly control the sensor/controllers of the actuators and/or the electronic control. The elevation of the wheelchair treadmill may be altered by activating the actuators 727 with the electronic control panel according to a preset schedule and/or in immediate response to user input. For example, a user may select on an electronic control 107 a training course selection which includes instructions that, when initiated and applied by the electronic control 107 during continued use, cause the electronic control to activate the actuators 727 (e.g., via corresponding sensors/controls at the actuators) to elevate the wheelchair treadmill to predetermined terrain simulation presets (heights defined by extension of the adjustable supports) in accordance with a predetermined timing schedule (e.g., for predetermined durations of time). In such instances, the user need not manually enter terrain change instructions into the electronic control 107 throughout their workout session, which allows the user to focus entirely on their exercise and form.

In some alternative embodiments, the electronic control 107 has preset slope settings/controls that are selectable on the electronic control 107 panel, corresponding to front tilt slopes, back tilt slopes, side tilt slopes and combinations of the above. When corresponding slope settings are selected from the electronic control 107, the corresponding actuators are dynamically activated until the corresponding slope(s) are obtained.

In some embodiments, the treadmill platform is also configured with accelerometers and gyroscopes that are electrically coupled to the control panel to track and measure the changes in the slope of the treadmill platform during use and to dynamically trigger additional utilization of the adjustable supports (actuators) by the control panel to adjust for undesired deviation in the slope(s) due to faulty actuators.

As illustrated in FIG. 7, the elevation device also includes one or more pivots, illustrated by way of example as ball pivot 729 and hinge pivots 731. The pivots 729, 731 allow the vertical alignment of the elevation devices 700 to respond to changes in the height of the elevation devices 700 without subjecting the elevation devices 700 (or the attachment mechanisms coupling the elevation devices 700 to the wheelchair treadmill or other frame(s)) to extreme torsional or lateral forces.

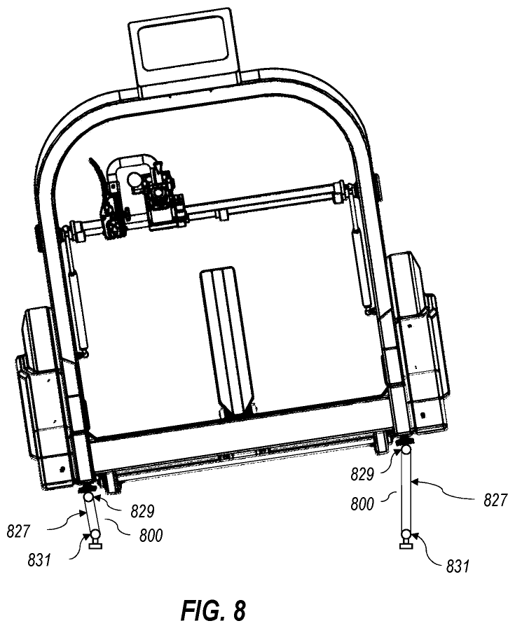

For example, turning to FIG. 8, when the actuators 827 of the elevation devices 700 are activated to effect a right-slanted terrain, as shown, the angle between the elevation devices 700 and the wheelchair treadmill also changes. The pivots 829 and 831 (shown as ball and socket joints) allow for this change in angle without overly straining the connection interfaces between the elevation devices 800 and the treadmill or other frame(s) by allowing the vertical alignment of the elevation devices 800 to change as needed. As shown, the vertical alignment of the left elevation device 800 is altered in that the elevation device is tilted to the left in order to accommodate the change in the tilt of the wheelchair treadmill brought about by elevating the right elevation device 800.

Returning to FIG. 7, in some embodiments the pivots 729 are configurable to connect to a receiving interface of the wheelchair treadmill. For example, the wheelchair treadmill may include one or more ball pivot sockets at locations depicted in FIG. 6 for receiving ball pivots 729 of the elevation device 700. Furthermore, in other embodiments, the pivots 731 are fixedly attached to one or more floor members 733 to provide stability to the elevation device 700. While in some embodiments the pivots 731 are each attached to a separate floor member 733 (i.e., one separate floor member per pivot 731), in other embodiments some or all of the pivots 731 of the elevation devices 700 are attached to a common floor member 733 shared with at least one other pivot 731 of a separate elevation device.

In yet other embodiments, the pivots 729 and/or 731 are configured to selectivey or fixedly connect to an intermediary frame which is couplable to a wheelchair treadmill. In such embodiments, modular tilt and dynamic terrain simulation systems may be constructed with a changeable configuration of elevation members 700, such that the modular tilt and dynamic terrain simulation systems may be reconfigured to fit a variety of treadmills or wheelchair treadmills, even existing treadmills that were not previously configured to include dynamic tilt capabilities.

Although the pivots 729, 731 are illustrated as a ball and socket pivots and hinge pivots, it will be appreciated that other pivots are within the scope of this disclosure, such as ellipsoid, saddle, and plane joint pivots.

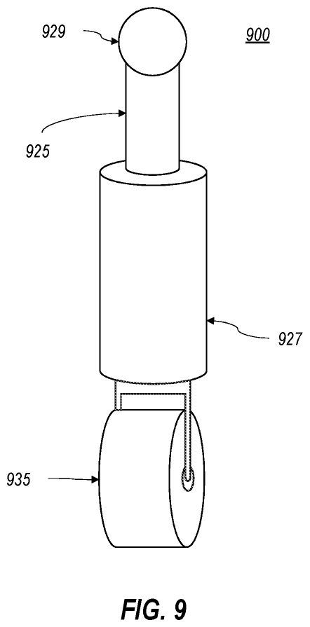

In some embodiments, where an elevation device is affixed to a slideable wheel receptacle (such as receptacle 104, 204 described above) the elevation device will need to be arranged to remain aligned and substantially perpendicular to the receptacle to which it is affixed. FIG. 9 shows a simplified schematic representation of an exemplary embodiment of an elevation device 900 which includes an actuator 927, adjustable support 925, a pivot 929 embodied as a ball pivot, and a roller 935. The roller 935, as shown, may be aligned such that it will roll in the same direction as the sliding direction of the front wheel receptacle to which the elevation device 900 is attached, thus remaining underneath and perpendicular to the receptacle.

Additional stabilization mechanisms (such as a telescoping track, not shown) may be employed to ensure the stability of the elevation device 900 as it rolls to remain aligned with the front wheel receptacle to which it is attached.

The elevation device 700 and/or 900 may be caused to move by an actuator. Different actuator mechanisms may be implemented to trigger the movement of the elevation device 700 and/or 900, including, but are not limited to, hydraulic, pneumatic, electric, twisted and coiled polymer, supercoiled polymer, thermal, magnetic, airbag or bladder, and mechanical mechanisms.

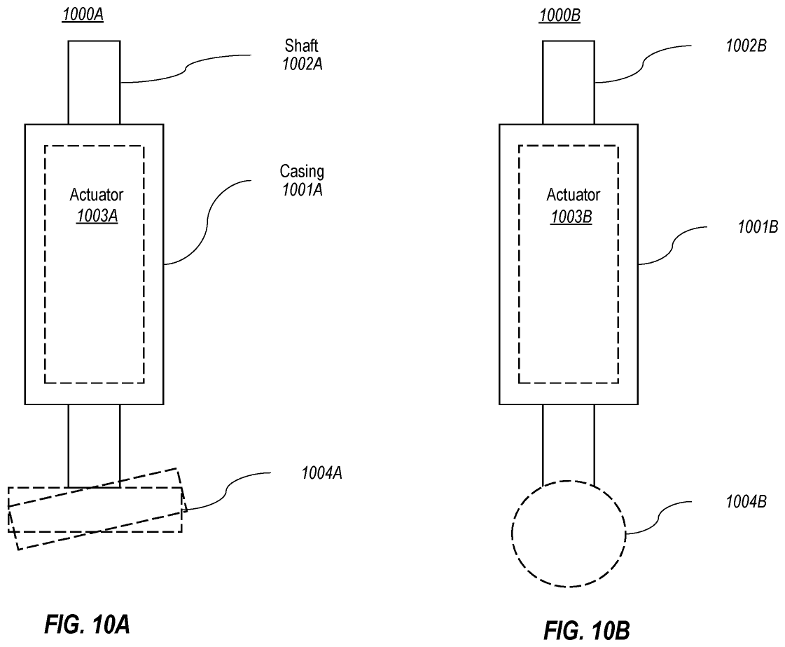

FIGS. 10A and 10B illustrate an example embodiment of actuator that may be implemented at a respective elevation device 1000A and 1000B. The elevation device 1000A may correspond to the elevation device 700 of FIG. 7, and the elevation device 1000B may correspond to the elevation device 900 of FIG. 9.

Referring to FIG. 10A, the elevation device 1000A may include a shaft 1002A, a casing 1001A, an actuator 1003A and a floor member 1004A. The floor member 1004A (which may correspond to the floor member 733 of FIG. 7) is rotatably connected to the shaft 1002A. The shaft 1002A is configured to support the platform of the treadmill (which may correspond to the treadmill platform 101, 201, 301, 401, 501 and/or 601 in FIGS. 1 through 6). An actuator 1003A is attached to the shaft 1002A to cause the length of the shaft to change or cause the shaft 1002A to move substantially vertically, such that the treadmill platform (e.g., 101, 201, 301, 401, 501 and/or 601) is caused to be tilted. The casing 1001A is configured to house the actuator 1003A. Note that the floor member 1004A illustrated in FIG. 10A appears to be able to be tilted, which merely indicates that the floor member 1004A and the shaft 1002A may have an angle that is not 90 degrees when the actuator 1003A changes the elevation of the platform. In operation, the floor member 1004A will always be in contact with the floor, and the shaft may tilt due to the movement caused by the actuator 1003A.

Similarly, FIG. 10B illustrates an elevation device 1000B that includes a shaft 1002B, casing 1001B, an actuator 1003B, and a roller 1004B. The roller 1004B functions similar to the floor member 1004A. When the treadmill (e.g., treadmill 100, 200, 300, 400, 500, and/or 600) is in operation, the roller 1004A may be locked or semi-locked, so that it cannot freely roll. When the treadmill (e.g., 100, 200, 300, 400, 500, and/or 600) is to be moved, the roller 1004A may be unlocked, so that the treadmill 100, 200, 300, 400, 500, and/or 600 can be easily moved.

Different actuator mechanisms may be implemented to cause the actuator 1003A or 1003B to move vertically. No matter what mechanism is implemented, a user may be able to control the actuator 1003A and/or 1003B via an electric control. The electric control may correspond to the control 107 of FIG. 1, 207 of FIG. 2, 307 of FIG. 3, and/or 407 of FIG. 4, each of which is attached to the treadmill 100, 200, 300, and/or 400. Alternatively, or in addition, the electric control may be a remote control that is detached or detachable from the treadmill 100, 200, 300, and/or 400. Alternatively, or in addition, the electric control may be an application that is installed at a user device, including, but are not limited to a mobile phone and a tablet.

FIG. 11 illustrates an example user interface 1100 that may be displayed on the above described electric control. A user can interact with the user interface 1100 to control the treadmill 100, 200, 300, and/or 400, including the tilt control related functions. As illustrated in FIG. 11, the user interface 1100 may include a main menu 1101. From the main menu 1101, a user may navigate to a tilt control sub-menu 1102. The tilt control sub-menu 1102 may include (but are not limited to) a variable/programed control 1103, right/left control 1104, and front/back control 1105.

The variable/programed control 1103 may allow a user to enter different values for a pre-programmed tilt program. For example, a pre-programmed tilt program (accessible through control 1103) may be a simulation of a dirt road, and a user can adjust the variables of the pre-programed dirt road, including (but are not limited to) a roughness indicator, a steepness indicator, a curvy indicator, etc. The roughness indicator may allow user to select a desired roughness of the simulated road. A higher roughness indicator may indicate a bumpier road, and a lower number may indicate a smoother road. The steepness indicator (not shown, but accessible through the control 1103 and/or main menu) allows a user to choose an uphill, downhill, and/or intermittent up and down hill under a pre-determined pattern. The curvy indicator (accessible through the control 1103 or main menu) allows a user to choose the angle of the turns, the frequency of the turns, left or right turns on the simulated path.

In some embodiments, a user can program his/her own exercise program, and store the programmed exercise program in the system for easy access. In other instances, the programmed exercise program is downloadable through the cloud or a wireless connection to a program source.

As another example, a pre-programmed tilt program may be a simulation of a particular trail, and a user can select the particular trail. A user may also be allowed to adjust certain variables of the selected trail. For example, a user may select a particular trail, and also adjust the roughness indicator, steepness indicator, and/or curvy indicator.

The right/left control 1104 may allow a user to choose to tilt the left side or right side selectively to simulate uneven road conditions or to simulate turns. The front/back control 1105 may allow a user to choose to tilt the front side or back side selectively to simulate uphill and/or downhill. In some embodiments, the user may be able to select a pre-programmed road condition via the control 1103, and at the same time modify the selected pre-programmed road condition by adjusting the right/left control 1104 and front/back control 1105.

The left/right and front/back controls 1104 and 1105 may allow a user to select a tilting angle (3 degrees) or a tilting distance (e.g., inches). Alternatively, a few preprogramed (or customizable) choices may be provided to a user, e.g., steep uphill, mild uphill, flat, mild downhill, etc. Other values for controlling the actuators and relative tilt of the device may also be selected or provided through the main menu 1101 and/or interface 1100 controls, when input is provided at the main menu 1101 and/or interface 1100 for accessing display fields/screens (not presently shown) for inputting the desired values.

The user interface 1100 illustrated in FIG. 11 is merely a simple example. Any other layouts, selections, sub-menus and/or controls may be implemented. For example, a visualization may be displayed to a user to simulate the view that a user may see after a pre-programmed road condition is selected. Further, the user may be allowed to program his/her own simulated road condition or trail. For example, the user may enter a distance for each piece of the trail, and customize each piece of the trail by entering the desired value at each controls. As another example, a visualization showing a number of selectable objects (e.g., a hill, a dirt road, a highway, a rocky road) may be presented to the user, and a user can select an object and place or move the selected object in the same or another visualization that simulate the road trip. The user may also be able to adjust the parameters of each object by interacting with the selected objects. For example, the user may be able to double tap the selected object (e.g., a hill) to adjust the elevation change, the angle of the hill, and/or the distance or curviness of the hill.

As disclosed herein, various embodiments of a tilt and dynamic terrain simulation system are provided, which are specifically configured to allow treadmills, including wheelchair treadmills with a single front wheel and two back driving wheels, to tilt in order to simulate various terrains, in particular terrains which may be encountered during wheelchair track and outdoor events. The embodiments disclosed include a plurality of elevation devices, which include one or more actuators, pivots, and adjustable supports, and which are configurable to attach, directly or indirectly, to a wheelchair treadmill. Disclosed embodiments are specifically configured to allow for dynamic terrain simulation.

It will be appreciated that the foregoing embodiments may also be configured to existing and new treadmills that are not wheelchair treadmills, but which are, instead, treadmills that are intended to be walked or run on.

In some embodiments, the invention also extends to methods for receiving/detecting user input at a control and, in response, causing one or more actuators of a treadmill to be activated to cause a piston/support connected to the actuator to extend or retract, relative to at least one other piston/support of an actuator attached to the treadmill, to cause the treadmill to tilt in a new orientation relative to an orientation of the treadmill that existed prior to the user input.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A wheelchair treadmill comprising:
a platform for supporting the wheelchair;
a dynamic tilt system coupled to the platform and configured to dynamically tilt the wheelchair during use of the wheelchair treadmill for simulating a terrain condition; and
an electronic control configured for controlling the dynamic tilt system.

2. The wheelchair treadmill of claim 1, wherein the terrain condition includes an uneven terrain condition, the uneven terrain condition being a non-horizontal plane condition.

3. The wheelchair treadmill of claim 1, wherein the terrain condition comprises a predetermined course corresponding to an existing outdoor or natural terrain.

4. The wheelchair treadmill of claim 1, wherein the dynamic tilt system comprises one or more elevation devices placed under the platform for tilting the platform of the wheelchair treadmill from a horizontal plane to a non-horizontal plane, wherein each of the one or more elevation devices is controllably adjustable to extend an adjustable support that is mounted to the platform between a first height and a second height.

5. The wheelchair treadmill of claim 4, wherein each of the one or more elevation devices comprises one or more actuators for controllably adjusting a height of the adjustable support between the first height and the second height.

6. The wheelchair treadmill of claim 4, wherein the electronic control is configured with one or more interface buttons for controlling the one or more actuators and for causing the adjustable supports to extend or retract from the elevation devices and for causing the adjustable supports to move and/or to stop moving between the first height and the second height.

7. The wheelchair treadmill of claim 4, wherein at least one of the one or more actuators is powered by electric current.

8. The wheelchair treadmill of claim 7, wherein the at least one of the one or more actuators includes a solenoid that is powered by electric current.

9. The wheelchair treadmill of claim 5, wherein at least one of the one or more actuators is powered by hydraulic fluid pressure.

10. The wheelchair treadmill of claim 5, wherein at least one of the one or more actuators is powered by pneumatic pressure.

11. The wheelchair treadmill of claim 5, wherein the dynamic tilt system comprises at least two adjustable supports and at least two corresponding actuators.

12. The wheelchair treadmill of claim 11, wherein the dynamic tilt system comprises at least three adjustable supports and at least three corresponding actuators.

13. The wheelchair treadmill of claim 12, wherein the dynamic tilt system comprises at least four adjustable supports and at least four corresponding actuators.

14. The wheelchair treadmill of claim 1, the wheelchair treadmill further comprising:
one or more rollers exposed through the platform for engaging the two driving wheels of the wheelchair during use of the wheelchair.

15. The wheelchair treadmill of claim 14, wherein the height of each of the one or two rollers are adjustable, and the dynamic tilt system is configured to dynamically adjust the height of each of the one or two rollers during use of the wheelchair treadmill.

16. The wheelchair treadmill of claim 15, the wheelchair treadmill further comprising:
a receptacle attached to the platform for receiving and restricting movement of the front wheel in at least one direction.

17. The wheelchair treadmill of claim 16, wherein the height of the receptacle is adjustable, and the dynamic tilt system is configured to dynamically adjust the height of the receptacle during use of the wheelchair treadmill.

18. The wheelchair treadmill of claim 17, wherein the height of the receptacle and the height of each of the rollers are all adjustable, and the dynamic tilt system is configured to dynamically adjust each of the height of the receptacle and the rollers during use of the wheelchair treadmill system.
